(19) United States
(12) Patent Application Publication
(10) Pub. No.: US 2006/0133193 A1
(43) Pub. Date: Jun. 22, 2006

(54) High pressure injection system for delivering therapeutic agents having fluid tight connector

(75) Inventor: Yves P. Arramon, Sunnyvale, CA (US)

Correspondence Address: ARTHROCARE CORPORATION, 680 VAQUEROS AVENUE, SUNNYVALE, CA, 94085-3523, US

(73) Assignee: ArthroCare Corporation, Sunnyvale, CA (US)

(21) Appl. No.: 11/016,418

(22) Filed: Dec. 17, 2004

(51) Int. Cl. B01F 13/00

(52) U.S. Cl. 366/139; 366/182.3

(57) ABSTRACT

Methods and systems are provided for the transfer of viscous therapeutic material from one chamber or device to another chamber or device in a fluidly sealed manner, wherein components of the system may be discrete or integrated. The system and methods provide for mixing and dispensing of therapeutic materials such as bone cement.

### FIELD OF THE INVENTION

The present invention relates to the sealed transfer of a therapeutic material from one device to another. More particularly, the invention relates to an assembly or port which optimizes the transfer of a viscous material from one device to another. The invention is particularly suitable for transferring the material from a mixing device to an injection device.

### BACKGROUND OF THE INVENTION

The introduction of viscous materials to an implantation site within a patient to affect one or more therapeutic goals is well known. Material ranging from typical fluids or solutions to non-Newtonian fluids, pastes, gels and the like has been used for one purpose or another in the medical arts.

A commonly injectable viscous material is bone cement. Bone cement is often used to affix a prosthesis to a bone or joint structure. Hip and knee joints are the most common examples of such prosthetic devices. Another common use of bone cement is for repairing or mending bone fractures or shattered bone or for supplementing a weakened bone structure, such as in the case of vertebroplasty. Bone cement may also be used for cosmetic or dental surgery. Moreover, bone cement may be used as a drug delivery or release system, whereby the bone cement is mixed with antibiotics or other desired drugs and applied to a specific surgical site such that the drugs leach out and are delivered directly to the surgical site. U.S. Pat. No. 6,383,190 describes a high pressure applicator for delivering a flowable implant material to a target tissue.

Bone cements are typically formed by mixing a polymer powder and a liquid monomer, such as polymethyl methacrylate (PMMA) or methyl methacrylate. In order to activate the bone cement, the components must be combined or mixed.

The two components forming the cement are first combined in a mixing container such as a bowl and then the material is transferred to a separate dispensing or injection apparatus. Conventionally, the cement is poured or spooned from the mixing device to the dispensing device. More recently, systems have been developed to provide for the transfer of the cement from the mixing container into the dispensing device. Examples of delivery or dispensing systems are found in U.S. Pat. No. 6,783,515, and U.S. Patent Application Serial No. 2003/0012080, each of which is incorporated by reference herein.

A shortcoming of the above described procedures is the escape of gaseous fumes of the bone cement during mixing and transfer from the mixing container to the injection system. This problem arises because the bone cement emits vapors as it is mixed. These vapors are toxic. Surgeons performing these types of surgical procedures desire to minimize their exposure to the toxic gaseous fumes. Additionally, air bubbles may be trapped in the cement during mixing. The air bubbles may compromise the quality of the bone cement to treat or repair the target bone. Also, exposure to the air or atmosphere may degrade or slow the curing time.

Accordingly, there exists a need for an improved mechanism and system for directly transferring viscous materials from one chamber to another in a completely sealed, airtight manner.

The system of the present invention includes apparatus and methods adapted to meet such needs as well as provide other advantages readily apparent to those with skill in the art.

### SUMMARY OF THE INVENTION

The present invention is a mechanism and improved system and method for the transfer of material from one chamber or device to another chamber or device, wherein the mechanism may be a discrete component or part of an integrated system. The invention is particularly suitable where the material is viscous and/or where it is preferential to maintain the material in a sealed environment where fumes from the material are unable to escape into the ambient air and the ambient air is unable to enter into the sealed environment.

In one variation of the present invention, a system is configured for mixing and injecting a viscous material, where the system includes a sealed mixing chamber for mixing two or more ingredients of the viscous material, a sealed injection chamber, and a material transfer mechanism for transferring the viscous material from the mixing chamber to the injection chamber in a sealed manner, wherein the material transfer mechanism is configured to prevent the transfer of the viscous material from the injection chamber back into the mixing chamber even if the injection pressures are high. The material transfer mechanism may include a one-way valve or the like.

The methods of the present invention include a method for preparing a flowable hardenable material for injection into the body, where the method specifically includes providing a first sealed chamber containing the material, providing a second sealed chamber configured to receive the material from the first sealed chamber, transferring the material from the first chamber to the second chamber in a sealed manner, and injecting the material contained in the second chamber into a target site within the body. Transferring the material involves sealingly engaging the first chamber with the second chamber, and injecting the material may include preventing the transfer of the material from the second chamber back into the first chamber. The type of material mixed in the first chamber may vary and it may be bioabsorbable, osteointegrable, or another type of material or combination of materials. An example of a material to be prepared or mixed in the first (or mixing) chamber is a PMMA bone cement. PMMA may be supplied in the mixing chamber in a powder and separate liquid monomer. The two ingredients are combined in the mixing chamber to form a flowable doughy cement material that is directly transferred into the injection chamber in accordance with the present invention.

In one application of the invention, a vertebroplasty method is provided which includes providing a sealed mixing chamber containing a bone cement material, and a sealed injection chamber configured to receive a material from the mixing chamber, mixing ingredients of a bone cement material in the sealed mixing chamber, transferring the bone cement material from the mixing chamber to the injection chamber in a sealed manner, and injecting the bone cement material contained within the injection chamber into at least one vertebra.

These and other objects, advantages, and features of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying drawings. It is emphasized that, according to common practice, the various features of the drawings may not be to-scale, and the dimensions of the various features may be arbitrarily expanded or reduced for clarity. Included in the drawings are the following figures:

FIG. 1A illustrates one embodiment of the present invention providing a viscous material injector having a material transfer mechanism for coupling with a viscous material mixing chamber or device. FIG. 1B is a cross-sectional view of a distal portion of the injector and of the material transfer mechanism. FIG. 1C shows a perspective view of a valve stem.

FIG. 2A illustrates a cutaway portion of another embodiment of the present invention in which a viscous material injector having integrated injection and mixing chambers is provided. FIG. 2A is a preferred figure to appear on the front page of any patent or publication to issue arising from this patent application. FIGS. 2B-2E illustrate various components of the system of FIG. 2A.

FIG. 2F is a top view of the valve stem shown in FIG. 2C.

FIG. 3A illustrates a cutaway portion of another embodiment of the present invention in which a viscous material injection system is provided having integrated injection and mixing chambers. FIG. 3B is an enlarged cross-sectional view of the material transfer mechanism of system of FIG. 3A. FIG. 3C is enlarged perspective view of the valve stem or plug of the material transfer mechanism of FIG. 3B.

FIG. 4A illustrates another embodiment of the present invention in which a viscous material injector is provided having a proximally positioned entry port. FIG. 4B is a cross-sectional view of the injector taken along the lines B-B of FIG. 4A.

FIGS. 5A-5E illustrate another embodiment of the present invention including a viscous material injector and an adaptor for coupling with any mixing device or chamber.

### DETAILED DESCRIPTION OF THE INVENTION

Before the present invention is described, it is to be understood that this invention is not limited to particular applications and embodiments described, and as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Although any method or materials similar or equivalent to those described herein can be used in the practice or testing of the present invention, the preferred methods and materials are now described. While the present invention is especially useful in injecting with bone cement, such as PMMA, and the invention is described with reference to such application, such description is not intended to be limiting and may be used with various injectable materials for various applications.

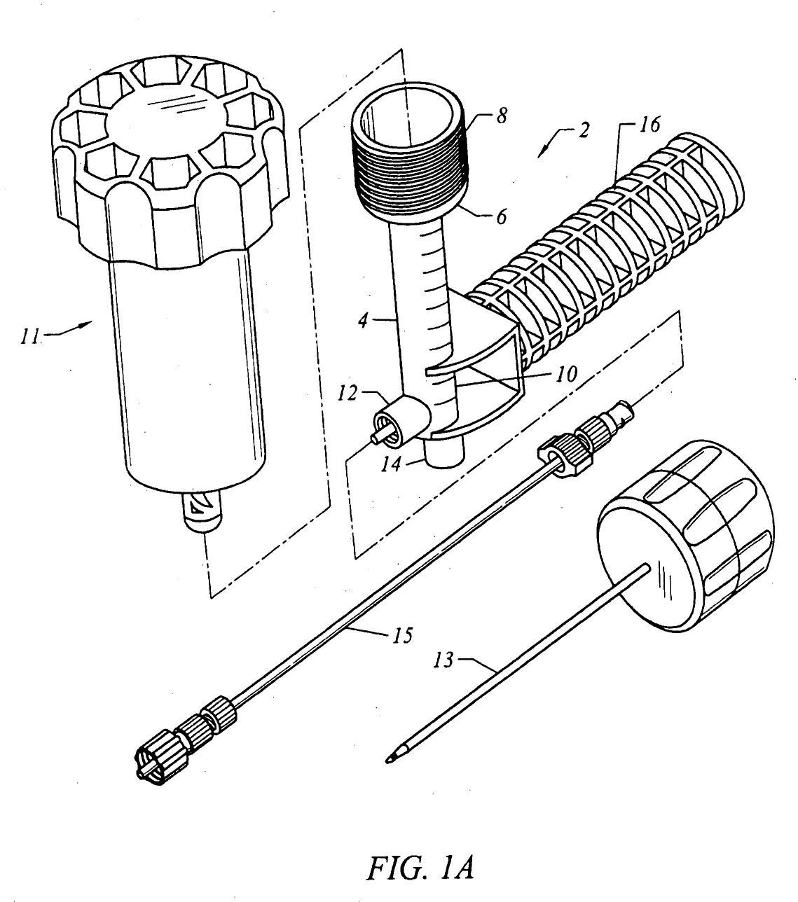

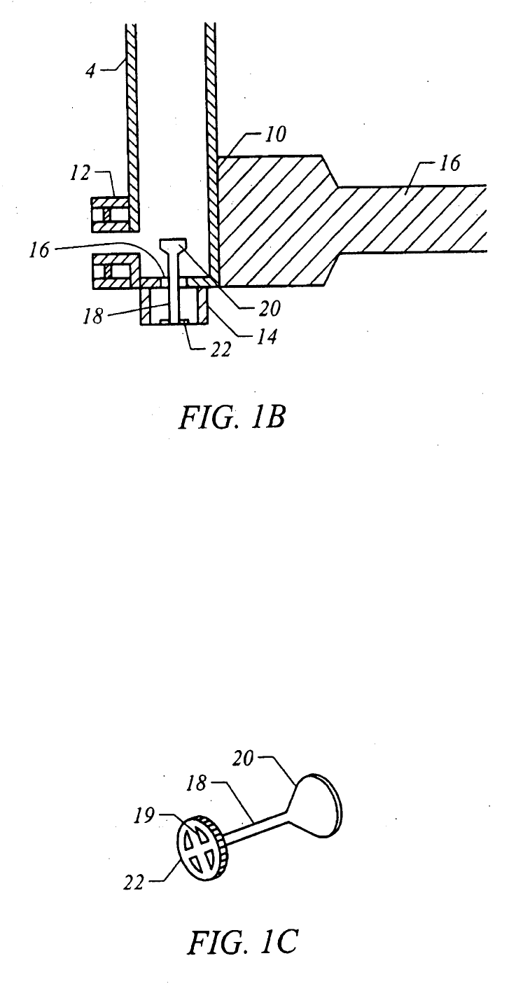

Referring now to the drawings, and to FIG. 1A in particular, there is illustrated an injection system 2 including a filling chamber 4 having a proximal portion 6 and a distal portion 10 and a cylindrical body portion therebetween. Proximal portion 6 has a funnel configuration to aid in receiving material poured into chamber 4. Drive threads 8 may be provided on the exterior of the funnel section to couple with a plunger or piston (not shown) to be used to drive the injectable material through the filing chamber 4 from proximal portion 6 to distal portion 10. One example of a plunger or piston 11 that may be used with the present invention is shown in U.S. Pat. No. 6,383,190. Although not shown, threads may be provided on the inside of proximal portion 6 to drive a piston member.

Extending substantially axially with distal portion 10 is a material transfer mechanism or material entry port 14 configured for coupling with a mixing device or chamber (not shown). Extending substantially transverse to the longitudinal axis of filling chamber 4 and proximally of material entry port is a material exit port 12 through which the injectable material exits the filling chamber 4 into a needle 13 or delivery conduit 15 upon being driven therefrom. As such, the axis of ports 12 and 14 are substantially transverse to each other but may be otherwise positioned. A handle 16 extends from filling chamber 4, preferably opposite exit port 12 for optimally directing and stabilizing system 2 during the filling and injection procedures.

FIG. 1B provides an enlarged cross-sectional view of distal portion 10 of injection device 2. Both exit port 12 and material transfer port 14 preferably have cylindrical configurations for easy rotational mating with a delivery conduit and mixing device, respectively. While exit port 12 may be valved or the like, it may be provided with an open lumen, as illustrated in FIG. 1B, which is in continuous fluid communication with the filling chamber 4. Material transfer port 14 is constructed with a valve mechanism or stem 18 axially positioned within the lumen of port 14. Valve mechanism 18 has an elongated central portion and proximal and distal transverse portions 20, 22 which are larger in diameter than opening 16 between chamber 4 and the lumen of port 14. Upon coupling with a port of a mixing device, valve mechanism 18 is caused to be in an open state, as illustrated in FIG. 1B, whereby the port's lumen is in fluid communication with chamber 4. Fluid material may also flow through apertures or channels 19 shown in FIG. 1C. As such, material injected from a mixing device causes valve stem to remain open and fill chamber 4. Upon decoupling of the mixing device from port 14, and application from the proximal direction of an injection force through chamber 4, such as by a piston or plunger mentioned above, valve stem 18 is translated distally. Proximal portion 20 is caused to enter and seal opening 16. The pressure within chamber 4 causes the material to then exit by way of exit port 12.

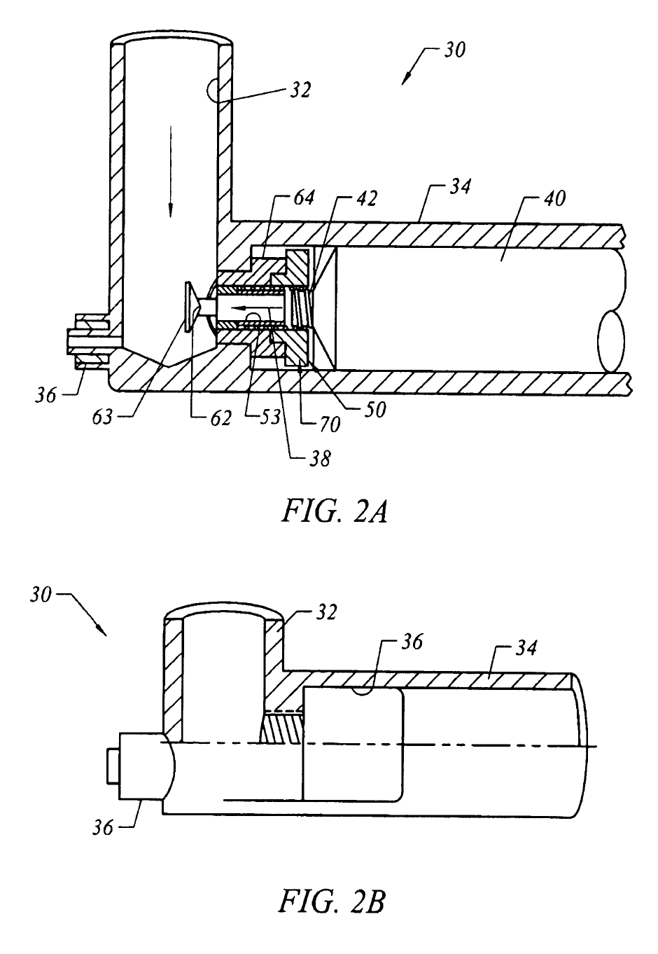

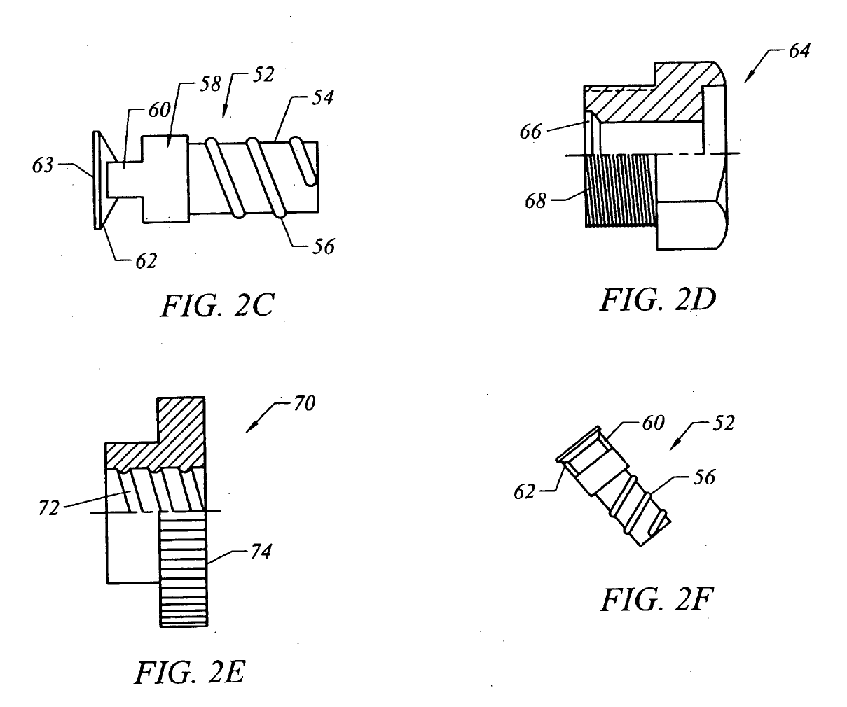

Another injection system 30 having a detachably coupled mixing device 40 is shown in FIG. 2A. A fluid connector assembly 50 is shown joining the injection device 30 to the mixing device 40 in a fluidly sealed manner such that no gaseous fumes or fluids may escape. Advantageously, the connector assembly 50 may be selectively opened to allow fluid to enter into the injector device as indicated by arrow 38 until the desired amount of viscous liquid is contained in filling chamber 32. The connector assembly may then be closed, shutting off all flow into the filling chamber 32.

Referring to FIGS. 2C-2F, the connector assembly 50 includes a stem 52, an anchor 64, and an actuator 70. In use, the stem 52 axially floats within anchor 64. The stem is prevented from axial rotation using a linear guide feature. The linear guide feature may be, e.g., a flat portion, ridge, or groove that guides the stem axially along the lumen of the anchor. Such a guide feature may be incorporated into the stem at area 58.

The connector assembly is shut off when stem head 62 is drawn into the anchor seat 66. The stem head is snugly drawn into the anchor seat by rotating actuator or knob 70. As shown in FIGS. 2A-2E, the knob 70 comprises grooves or threads 72 that interlock with the mating threads 56 of the valve stem 52. As the knob 70 is rotated in a first direction, it draws valve head 62 towards the mixing device until valve head is fully positioned in the anchor seat. Rotating the knob in a second direction, opposite of the first direction, opens up the connector assembly 50. In this manner the connector assembly may be conveniently opened and closed through window 36 of the injector assembly handle 34.

The mixing cartridge 40 preferably contains all components necessary to form a flowable hardenable bone cement. For example, the cartridge may contain an enclosed ampoule of monomer, and a powder that reacts or polymerizes when combined with the monomer. The contents of the cartridge may be activated and expelled by a plunger (not shown) that forces the combined mixture out of the cartridge and into the injector device 30 via connector assembly 50. An example of a known mixing cartridge is disclosed in U.S. Pat. No. 5,435,645 to Faccioli et al, which is incorporated by reference in its entirety.

Additional materials may be added or contained within the cartridge as desired. For example, radiopaque tracer particles may be added to facilitate visualization and/or medicines may be added. Tracer particles are described in U.S. Pat. No. 6,309,420. Preferably, the mixing cartridge 34 is fully self-contained such that no materials need to be added by the doctor during a surgical procedure. To this end, the cartridge is prepackaged and the surgeon simply attaches the self enclosed cartridge to the injector by, for example, screwing the threads 42 of the cartridge to the connector assembly 50. The cartridge 40 may thus be detachably (or non detachably) coupled to the injector system.

The connector assembly may be fabricated from a wide variety of materials. An exemplary material may be injection molded plastics. An example of a material is nylon. The connector assembly may be provided permanently attached to (or integrated with) the injector device or it may be separately fastened to the injector assembly with, for example, threads 68 that match with threads in a port of the injector assembly.

The connector assembly also ensures that no back flow of viscous material from the filling chamber will flow into the mixing chamber because of the shape of the stem head 62. The stem head 62 shown in FIG. 2A includes a surface 63 that becomes substantially flush with the inner wall of the filling chamber. As viscous material is expelled from the filling chamber 32 through outlet 36′, valve head 62 is forced into anchor seat 66. The increased fluid pressure causes the seal of connector assembly to be stronger. In a sense, shutting off the connector assembly is fail proof during ejection of bone cement from the chamber 32.

As shown in FIG. 2A, the stem 52 includes an inner lumen 53. Inner lumen 53 is desirably as large as possible to maximize fluid flow therethrough. It is also desirable that bridge members 60 (shown in FIG. 2F) define a large enough opening/gap to allow sufficient flow of material therethrough. However, bridge members 60 must be sufficiently strong to allow head 62 to be drawn into anchor seat 66 without detaching. Preferred materials are those that are stiff, strong, and resistant to solvent attacks such as Nylon polymers or metals such as steel.

Although the dimensions of the present invention may vary widely, an exemplary lumen diameter may be from about 0.2 to 0.4 inches. The diameter of the filling chamber may be from about 0.5 to 0.8 inches. The valve stem is preferably long enough to accommodate the stem travel plus a few threads of travel. For example, the stem may range from 0.5 to 1 inches long. Additionally, knob 70 preferably has a sufficient number of threads to accommodate both the mixing cartridge threads and the travel of the valve stem. The above mentioned dimensions are intended as exemplary dimensions and unless specifically recited in the claims are in no way intended to limit the invention.

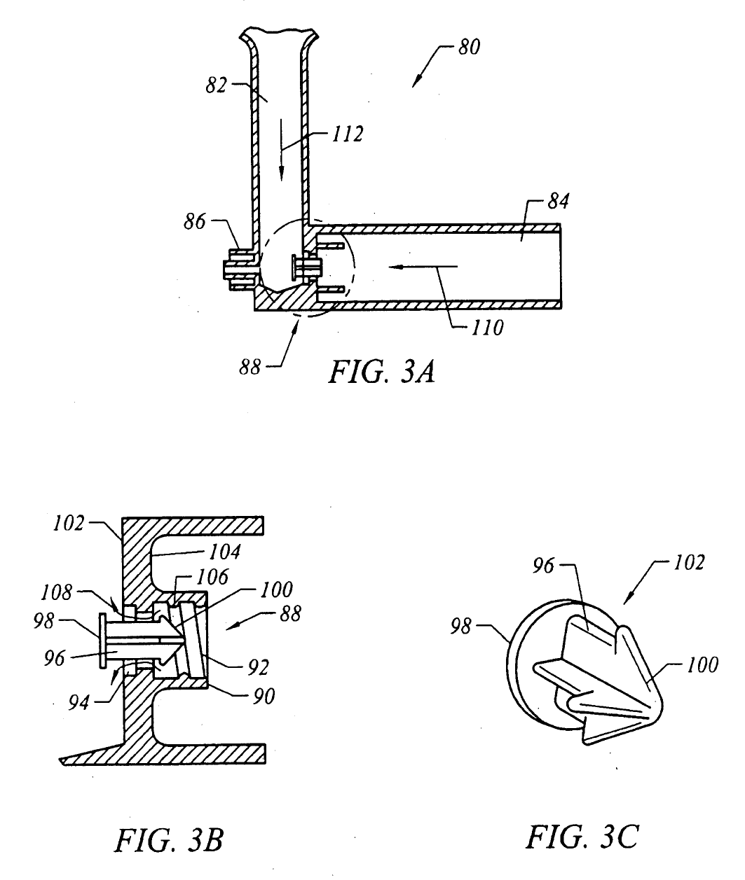

Another variation of the present invention is illustrated in FIG. 3A. An injection system 80 is provided having an injection chamber 82 and a chamber 84 transversely positioned relative to injection chamber 82. Chamber 84 may act as a reservoir for receiving injectable material or for receiving a mixing or filling cartridge (not shown) containing injectable material. At the distal end of injection chamber 84 is an exit port 86 as described above with respect to the other inventive embodiments. At the juncture of chambers 82 and 84 is provided a material transfer mechanism 88, an enlarged cross-section of which is illustrated in FIG. 3B.

A wall 104 separating chambers 82 and 84 provides a passageway or port 106 through which a plug member 102 is positioned. Port 106 may be internally threaded in applications where a removable mixing chamber is to be received and engaged within chamber 84. As best illustrated in FIG. 3C, plug 102 has an arrow-like design having a flared proximal base 98 and a tapered distal tip 100 and a body 96 extending therebetween. Plug body 96 has a cross-sectional configuration in the shape of a cross or the like to provide one or more flow paths, illustrated by arrows 108 in FIG. 3B, between it and opening 94 within wall 104. This plug is unlike the stem shown above in that the plug does not define or contain a lumen for the fluid to run therethrough. The plug, in contrast, defines sections or channels for fluid to flow. Accordingly, valve stem and plug geometries may vary widely to provide channels and/or lumens for fluid to flow through.

In use, a plunger or piston mechanism (not shown) is used to drive or distally advance the injectable material from mixer chamber or material reservoir 84 in the direction of arrow 110 of FIG. 3A. The pressure causes the material to force plug 102 so that tip 100 abuts and anchors against wall 104. The cross configuration of plug body 96 allows the material to pass through opening 94 into injection chamber 82. Upon the desired filing of chamber 82, another plunger or piston mechanism (not shown) is used to drive or distally advance the injectable material in injection chamber 82, in the direction of arrow 112 of FIG. 3A, out through exit port 86. The injection pressure is sufficient to cause plug 102 to move distally into the mixing reservoir 84 until base 98 abuts wall 104, thereby sealing the two chambers from each other.

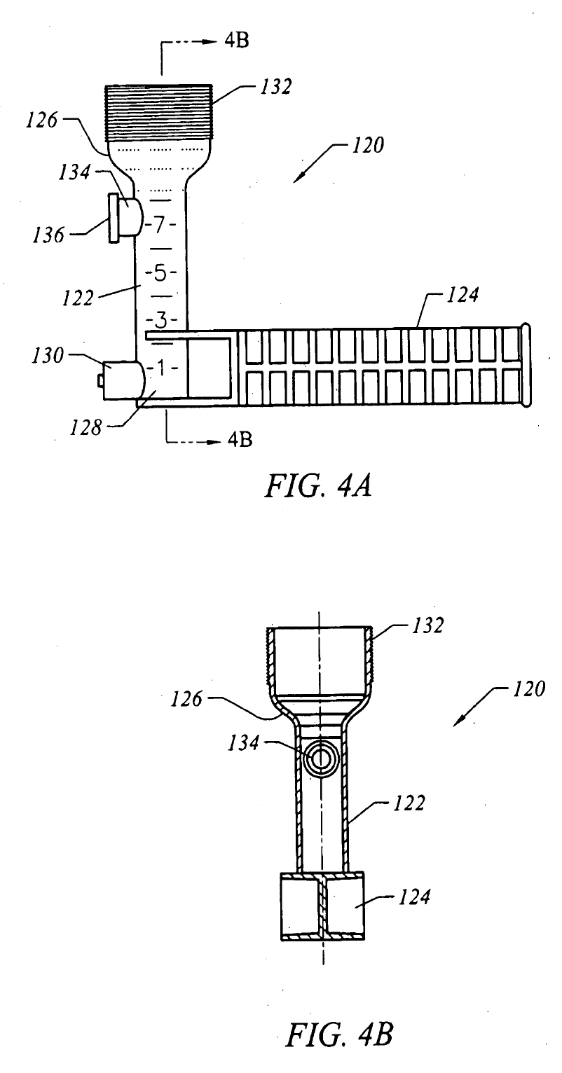

FIGS. 4A and 4B illustrate another variation of the present invention in which an injector device 120 includes a filling or injection chamber 122 and a transversely extending handle 124. Chamber 122 has a funneled proximal end 126 having a threaded opening 132 for engaging a plunger or piston (not shown). At a distal end 128 of chamber 122 is an exit port 130 for injecting the material into a cannula or other delivery conduit (not shown). Proximally positioned of exit port 130 is a filling port 134 within chamber 122 for coupling to a mixing device and for receiving the injectable material within chamber 122.

During a procedure to dispense bone cement, for example, the plunger or piston is urged downward, dispensing bone cement from the exit port 130. As the plunger is urged downward it covers entry port 136, preventing back flow into mixing chamber. As such, a lightly secured cap 136, rather than the more tightly secured valve and plug mechanisms described above, need be used to prevent back flow of material through filling port 134. The port 136 is not exposed to the potentially high pressure of injection because the port shall be behind (or upstream) the actuating plunger.

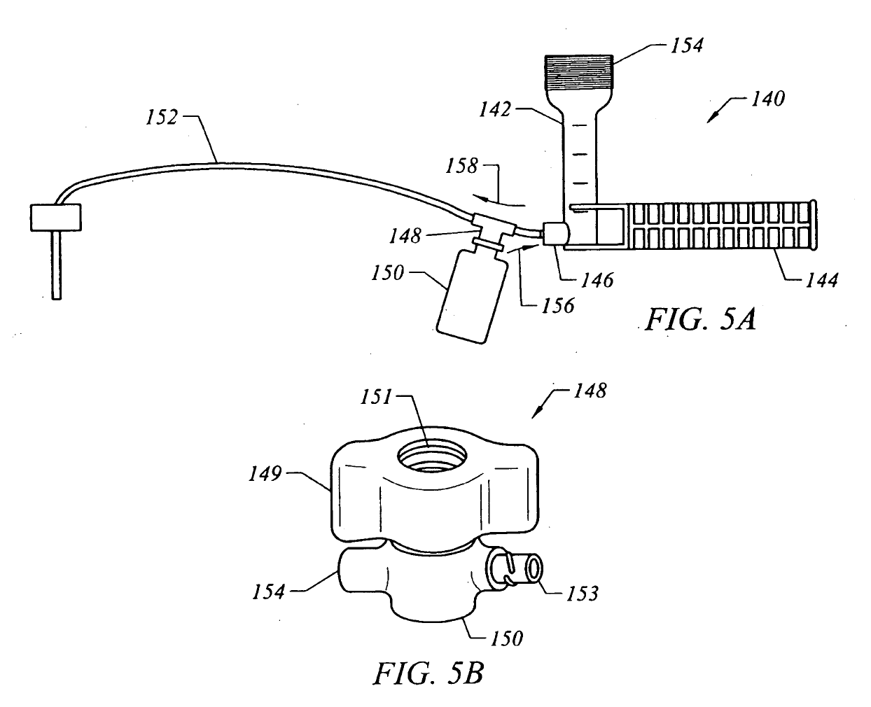

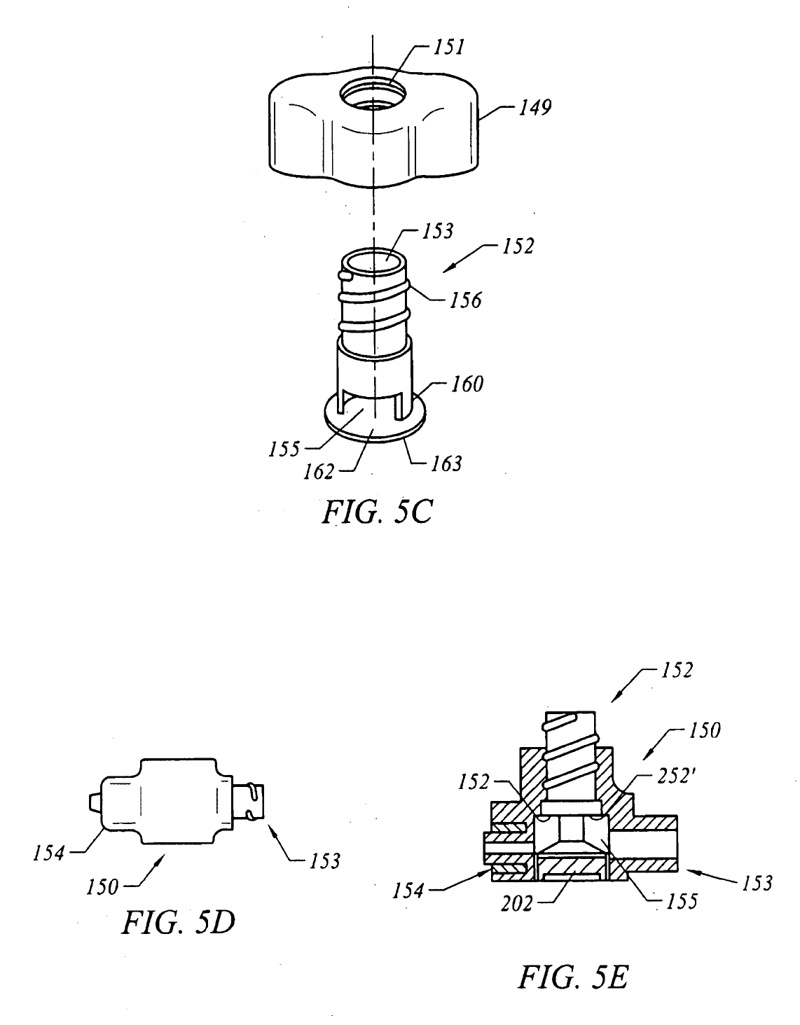

FIGS. 5A-5E illustrate an adapter 148 that fluidly connects or couples a mixing device 150 to an injection device 140. The adapter 148 may fluidly couple the devices even if neither device is specifically designed for direct transfer of the injection material. The adapter generally includes a knob 149 that may be rotated to open and close the adapter as will be discussed in greater detail below.

Adapter 148 is shown having a knob 149, a body 150, and a valve stem 152 movably positioned within body. Knob 149 includes an aperture 200 and a thread feature 151. Threaded feature 151 of knob 149 is intended to accommodate and interlock with a corresponding threaded feature on the mixing device 150. The threaded feature 151 preferably has a pitch and thread profile consistent with medical Luers. As such this would make it compatible with fluid connectors of most medical devices. However, the ports and openings may be provided with other features to fluidly connect with one another.

The valve stem 152 floats in an axial direct and is not allowed to rotate. Rotation of the stem may be prevented any number of ways including providing a guide, flat region, or groove on the stem that slidably mates with an associated feature of the body 150. Referring to FIG. 5E, stem threads 156 are provided on the stem to match threads 151 on the knob 149 so that by rotating the port knob 149, the valve stem surface 162 will seat against the port body 150 and surface 252 thereby sealing and preventing back flow of material into the mixing device 150 during operation of the injection device.

Port body 150 is shown having female 153 and male 154 Luer connecting ports. These ports are intended to accommodate the corresponding ports on an injector 140 and a connecting tube 152. Luer-type connectors are preferred because it is a common type of fluid connector in the medical device industry. The body 150 also may be sealed with a cap or plug 202. Such a plug may be glued in place or otherwise secured in place after the adapter is assembled. The adapter may be fabricated from materials similar to the devices described above. For example, the device may be comprised of Nylon.

In operation or use, the adapter is connected to an injection device 140. A mixing device may then be connected to the adapter as described above. A flexible conduit or delivery tube may be connected to the adapter as well.

The knob 149 is then rotated to displace or urge the stem downward into the body 150. The mixing cartridge may then be actuated and the flowable material may be injected from the mixing device through the adapter into the injection device. Of course, some mixed material may flow into the flexible conduit 152. However, a majority of the cement should flow through the path of least resistance and thus, into injection chamber 147.

Once the mixed flowable material has filled the injection device, the knob 149 is rotated to seat the valve stem in the valve body closing off the flow pathway to the mixing device. Material may now only flow from the injection device, through the adapter, into the conduit 152. As such, the present adapter assembly may sealingly join a self-contained mixing device (or cartridge) to a separate injection device regardless of whether either device was intended to be joined with one another. The adapter 148 may thus convert an injector into an integrated mixing and injection system.

As mentioned above, the systems, devices and material transfer mechanisms of the present invention are particularly useful for the transfer of bone cement from one chamber to another, for example, in the context of vertebroplasty applications. As such, the present invention provides a method of performing an orthopedic procedure which includes the mixing of materials, such as a polymer powder and a liquid monomer to form polymethyl methacrylate (PMMA), within a mixing device or chamber, preferably in a sealed device or chamber such that no fumes from the material are released into the environment. The method further includes transferring the mixture from the self-enclosed mixing device or chamber to an injection device or chamber, also without the release of fumes, and then injecting the material to a target site within the body.

The present invention may also include those concomitant parts or elements useable with the subject systems and devices in delivering material to a site within a patient. Such elements may include a delivery hose, a cannula (alone or in combination with one or more stylets) and the injectable material, e.g., the bone cement. Together, these elements may form part of the inventive kit or system to be used in a procedure or method as variously described herein. A plurality of such elements and devices may be provided where the devices have the same or varying sizes. The kits may further include instructions for mixing implantable material, transferring the implantable material from a mixing device or chamber to an injection device or chamber, and injecting the implantable material into a target site within the body.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A system for mixing and injecting a viscous material, the system comprising:
a sealed mixing chamber containing at least a precursor composition such that when the components of the precursor composition are combined, a flowable hardenable viscous material is formed;
a sealed injection chamber; and
a material transfer mechanism for transferring the viscous material from the mixing chamber to the injection chamber in a sealed manner, wherein the material transfer mechanism is configured to prevent the transfer of the viscous material from the injection chamber back into the mixing chamber.

2. The system of claim 1 wherein the material transfer mechanism comprises a one-way valve.

3. The system of claim 1, wherein the injection chamber is configured for receiving a plunger in sealed engagement therewith and further comprises a material exit port, and wherein the material transfer mechanism comprises a material entry port within the injection chamber.

4. The system of claim 3, wherein the material exit port is positioned proximally of the material entry port in the direction of the line travel of the plunger.

5. The system of claim 4, wherein the exit and entry ports define axes which are substantially transverse to each other.

6. The system of claim 3, wherein the material exit port is positioned distally of the material entry port in the direction of the line travel of the plunger.

7. The system of claim 6, wherein the exit and entry ports define axes which are substantially parallel to each other.

8. The system of claim 1, wherein the viscous material is bone cement.

9. The system of claim 1 wherein said material transfer mechanism comprises an anchor having an axial bore, the anchor further being adapted to sealingly join with a material entry port of the injection chamber; a valve stem axially movable within the said axial bore and said valve stem comprising a valve head that is shaped to fluidly shut said axial bore when positioned in a seat of the anchor.

10. The system of claim 9 wherein said material transfer mechanism further comprises a valve actuator for manipulating said valve stem axially to open and close said material transfer mechanism.

11. The system of claim 10 wherein said material transfer mechanism comprises grooves that grip threads on said valve stem.

12. The system of claim 1 wherein said sealed mixing chamber is adapted to detachably couple to said sealed injection chamber.

13. The system of claim 9 wherein said mixing chamber is adapted to detachably couple to said material transfer mechanism.

14. The system of claim 13 wherein said mixing chamber is adapted to detachably couple to said valve actuator.

15. The system of claim 14 wherein said valve actuator comprises a knob.

16. The system of claim 9 wherein said valve stem comprises a fluid ingress, fluid egress, and a fluid passageway therebetween wherein said egress is covered and shut off when said valve head is positioned in said anchor seat.

17. The system of claim 12 further comprising a handle radially extending from said injection chamber, said handle including a cavity shaped to receive said sealed mixing chamber.

18. The system of claim 17 wherein said handle includes a window that provides access to said material transfer mechanism.

19. The system of claim 2 wherein said valve is adapted to be manually sealed.

20. The system of claim 2 wherein said valve is adapted to withstand backpressure greater than 1000 psi.

21. A method of preparing a flowable settable material for injection into the body, the method comprising:
attaching a first sealed chamber to a second sealed chamber configured to inject the flowable settable material, said first sealed chamber containing a precursor composition;
activating the precursor composition to form said flowable settable material in said first sealed chamber;
transferring said material from the first chamber to the second chamber in a sealed manner; and
injecting the material contained the second chamber into a target site within the body.

22. The method of claim 21, wherein said second sealed container comprises a handle that is adapted to receive said first sealed container.

23. The method of claim 21, wherein the injecting the material comprises preventing the transfer of the material from the second chamber back into the first chamber.

24. The method of claim 21, wherein said precursor composition comprises a bone cement powder and liquid bone cement activator.

25. The method of claim 24 wherein said injecting step comprises
injecting the bone cement material contained within the injection chamber into at least one vertebra.

26. A method of performing a vertebroplasty procedure comprising:
providing an injection chamber for dispensing a bone cement, said injection chamber comprising an entry port;
attaching a material transfer assembly to said entry port of said injection chamber;
fluidly coupling a supply cartridge to said material transfer assembly;
driving said contents of said supply cartridge into said injecting chamber, said contents mixing in said supply cartridge during said driving step to form a settable flowable material;
dispensing said material from said injection chamber into a vertebral body.

27. A viscous fluid transfer assembly for fluidly connecting a first barrel and a second barrel of a bone cement injection system, said first barrel comprising an entry port and said second barrel comprising an exit port, said assembly comprising:
a valve anchor adapted to be coupled with said entry port of said first barrel;
a valve stem axially movable within a bore of said valve anchor, said stem comprising a fluid ingress, a fluid egress and a passageway therebetween, and an enlarged head distal to said fluid egress, said stem further being associated with said anchor to close and seal said axial bore when said head is manipulated into a seat of said anchor and said stem causes said fluid egress to be covered.

28. The assembly of claim 27 further comprising a valve actuator to manually manipulate said valve stem to open and close fluid flow.

29. The assembly of claim 27, wherein said passageway is one of a channel and a lumen.
